(19) United States
(12) Patent Application Publication
(10) Pub. No.: US 2016/0140076 A1
(43) Pub. Date: May 19, 2016

(54) APPARATUS FOR TRANSFERRING DATA BETWEEN DEVICES

(71) Applicants: Paul Shoni Doe, Lancaster, CA (US); Leah Rachel Evans-Doe, Lancaster, CA (US)

(72) Inventors: Paul Shoni Doe, Lancaster, CA (US); Leah Rachel Evans-Doe, Lancaster, CA (US)

(21) Appl. No.: 14/542,584

(22) Filed: Nov. 15, 2014

(51) Int. Cl. G06F 13/42; G06F 13/40

(52) U.S. Cl. CPC G06F 13/4282; G06F 13/4081

(57) ABSTRACT

An apparatus comprises a housing comprising a generally oblong shape with a first lateral side, a second lateral side, a first lateral end and a second lateral end. A memory device is disposed within the housing. A first connector is disposed on the first lateral end and is configured for connecting with a host computer. The first connector is connected to the memory device. The first connector has a slot for accepting a microSD card, wherein the host computer, in communication with the first connector, has access to the memory device and a microSD card inserted in the slot. A second connector is disposed on the first lateral side and is configured for connecting with a portable computing device, wherein the portable computing device, in communication with the second connector, has access to the memory device and a microSD card inserted in the slot.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to flash memory and memory card readers. More particularly, the invention relates to the transfer of data from a smart device to a multitude of devices.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

As the sophistication of computing has grown over the years, so has the need for more efficient ways to store and to transfer data from one computing device to the other. Notable are portable media such as the USB drive and the microSD card.

The USB drive, which constitutes a portable storage medium with a standard universal serial bus (USB) connector, is more popular than the external hard-drive for data storage and transfer. While the USB, which runs on flash memory, typically holds less data than an external hard drive, the elimination of a power cord makes the USB drive more convenient. Nevertheless, flexibility has been sacrificed: the onboard memory of the USB drive is neither replaceable nor expandable. Another issue pertains to a third medium, the microSD card, which is limited to files for music, photos, and videos. The microSD reader simply reads or deletes data in the micro-flash memory or writes data into the microSD card. It is believed that since the microSD card is extremely small it is typically not considered a convenient type of memory to carry around openly. It is further believed that most manufactures have shied away from integrating microSD drives as prevalent as the current USB drive standard. The limitations of each of these media have long been criticized by consumers. In view of the foregoing, it is clear that these traditional approaches leave room for more optimal approaches.

The following are examples of specific aspects in the prior art that, while expected to be helpful to further educate the reader, are not to be construed as limiting the present invention, or any embodiments thereof, to anything stated or implied therein or inferred thereupon. One such aspect of the prior art appears to allow the user to transfer files from an Android® smartphone or tablet to the user's PC or Mac® computer via a single drive that features a micro-USB connector on one side and a USB 2.0 connector on the other. Moreover, it appears that the drive's connectors are protected by sliding plastic sheaths that automatically retract when the connectors are inserted in their respective ports. It is believed to show onboard memory is available in 16 GB, 32 GB, and 64 GB.

By way of educational background, another generally useful aspect of the prior art is believed to teach of a device where the user is able to transfer files from an from an iPhone® or a tablet to a PC or Mac® computer via a device that incorporates the Lightening® and the USB 2.0 connectors for the iPhone®, the iPad Touch®, and the iPod Touch®. The device appears to include onboard memory and a USB-enabled card reader. The device also appears to comprise two pieces.

By way of educational background, a third generally useful aspect of the prior art is believed to teach of a device where the user is able to transfer files from an Android® smartphone or tablet to a PC or Mac® computer via a dual USB key with a micro-USB connector on one end and a USB 2.0 connector on other. The device also appears to feature (1) a cap that is attached with a tether and (2) an LED to indicate data transfer. Onboard memory appears to be available in 8 GB, 16 GB, and 32 GB.

By way of educational background, a fourth generally useful aspect of the prior art is believed to teach of a device where the user is able to transfer files from an Android® smartphone or a tablet to a PC or Mac® computer via a mini, dual Android® USB key that features a micro-USB connector on one end and a 32 GB, USB-enabled microSD card reader on the other. This device is believed to show an included key-ring clip and a single tether that is threaded through the body of the key for both caps.

However, none of these approaches incorporates the strengths, while eliminating the weaknesses, of the hard drive, the USB drive, and the microSD card in a device which features (1) a USB drive and a microSD card reader for increased data storage and management, (2) two microSD storage compartments, (3) a profile that does not impede the charging of a smartphone, and (4) non-removable, retractable caps. A solution which does so is desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1F are illustrations of an exemplary device of a microSD reader with two types of device connectors and with at least one type of device receptacle, in which FIG. 1A is an exploded view, FIG. 1B illustrates a top view in the retracted position and FIG. 1C illustrates a top view in the closed position, FIG. 1D illustrates the left side view, FIG. 1E illustrates the right side view, and FIG. 1F illustrates the bottom view, in accordance with an embodiment of the present invention;

FIG. 2 illustrates an exemplary device 100 inserted into an OTG smart device, in accordance with an embodiment of the present invention;

FIG. 3 illustrates an exemplary method for using the device 100, in accordance with an embodiment of the present invention;

FIG. 4 illustrates an exemplary method for adding storage to the device 100, in accordance with an embodiment of the present invention;

FIG. 5 illustrates an exemplary method for ejecting the device 100, in accordance with an embodiment of the present invention; and

FIG. 6 illustrates an exemplary method for downloading music from the device 100 to iTunes® software on a computer, in accordance with an embodiment of the present invention.

Unless indicated, illustrations in the figures are not necessarily drawn to scale.

### DETAILED DESCRIPTION OF SOME EMBODIMENTS

The present invention is best understood by reference to the detailed figures and descriptions set forth.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Standard Smart devices, such as the popular iPhone and Android series, typically comprise at least one video camera, at least one light source (which may be a high intensity LED light designed for flash photography, or which may be a backlit video display screen), at least one microphone and at least one sound output device, at least one processor, at least one video display screen, at least one charging port, and device operating software, such as iOS for Apple iPhones, the Android operating system for Android devices, and so on. Moreover, in Apple iPhones, the charging port is also used as an eight pin Lightning® port where typically, Lightning connectors and adapters are used to attach peripheral to the iPhone. On the other hand, Androids typically utilize a micro-USB port as a charger port.

In general, as used in this specification, the term “Smart device” is intended to encompass, without limitation, both iPhones and Android series smartphones. As such, the present embodiment device 100 acts as an external memory for the Android OTG enabled smart devices and iPhone 5, 5s, and 5c OTG enabled smart devices.

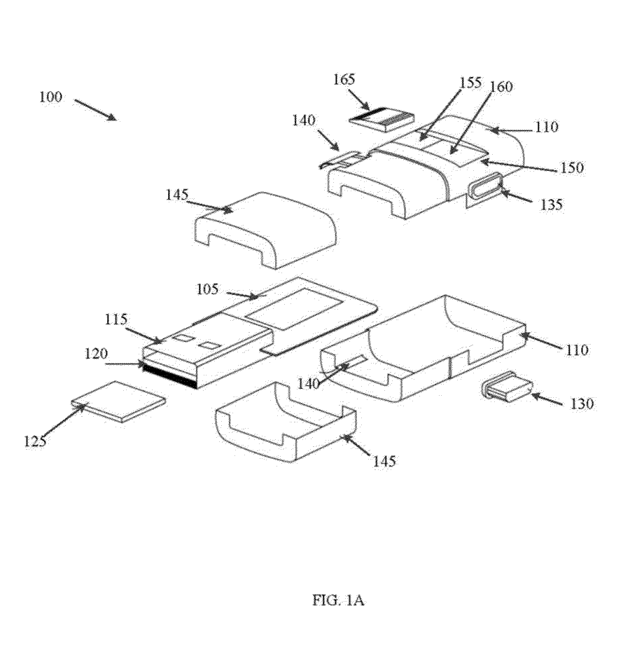

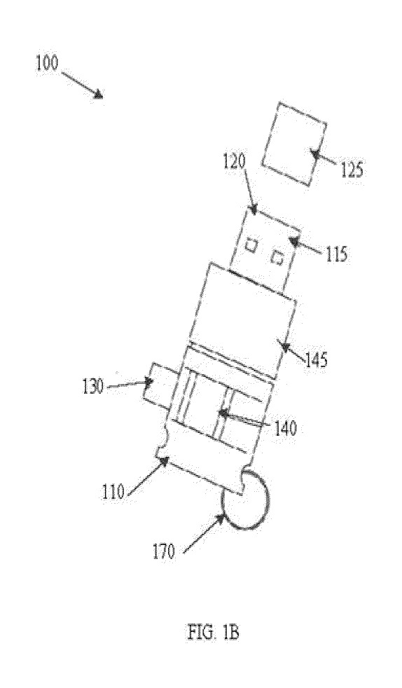

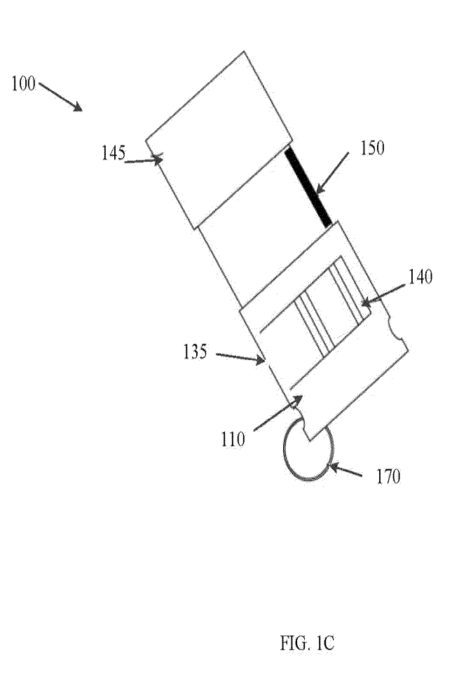

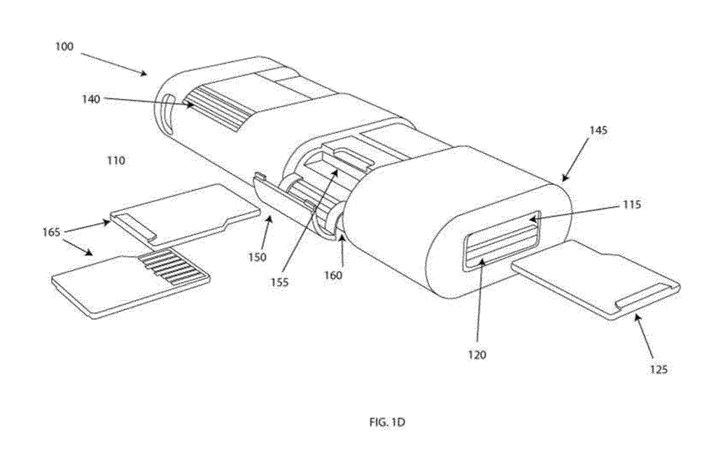

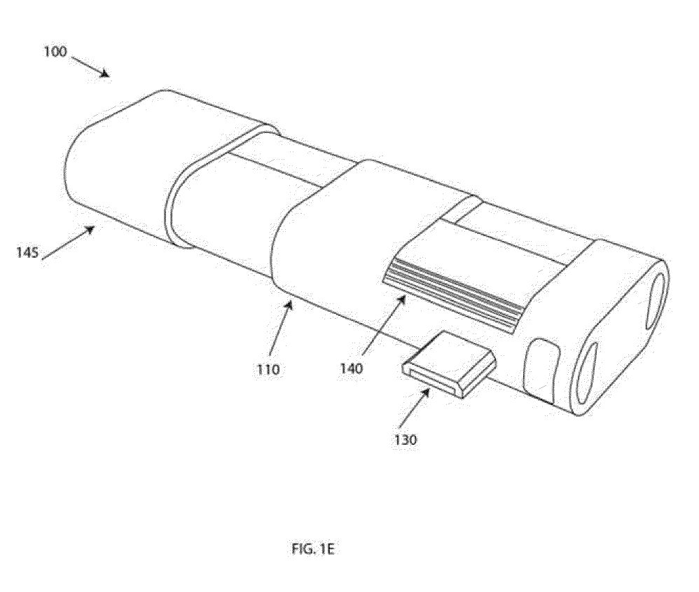

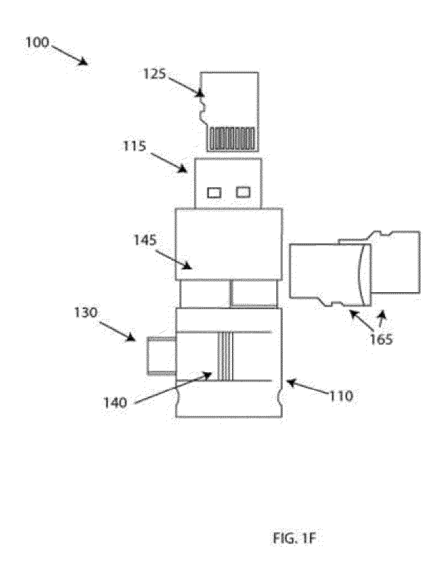

FIGS. 1A-F illustrate various views of an exemplary device of a microSD reader with two types of device connectors and with at least one type of device receptacle, in which FIG. 1A is an exploded view, FIG. 1B illustrates a top view in the retracted position and FIG. 1C illustrates a top view in the closed position, FIG. 1D illustrates the left side view, FIG. 1E illustrates the right side view, and FIG. 1F illustrates the bottom view, in accordance with an embodiment of the present invention. In the present embodiment, the device 100 contains a flash-memory circuit board 105 within a housing 110. In a non-limiting example, the housing 110 typically comprises two pieces of lightweight, durable plastic that attach together to seal the circuit board 105 within as represented in FIGS. 1B, 1C, 1D, 1E, and 1F. In the present embodiment, a metal USB female connector 115 attaches to circuit board 105. The USB female connector 115 is modified to house a microSD reader drive and a microSD slot 120 that meets the specification of a USB A-Type connector dimensions and an isolation substrate enclosed by the metal housing 115. The first surface has a first slot in electric connection to a USB female connector 115. The thickness of a portion of the isolation substrate is less than 1.2 mm, which allows a second slot 120 for the insertion of a thin microSD card 125. Moreover, multiple metal terminals are located on the second surface for an electrical connection to the microSD card 120, such that the second slot is formed as a card-reading slot for the microSD card 120. In a non-limiting example, the FIGS. 1A, 1B, 1D, and 1F demonstrate the insertion of a microSD card 125 in a microSD reader drive slot 120 within the metal housing of the USB female connector 115. In another non-limiting example, the flash memory reader may have up to 64 GB of storage while the flash-memory circuit board 105 may have up to 128 GB. In the present embodiment, both the memory card 125 and the flash-memory circuit board 105 may be used together simultaneously, providing the user with 192 GB of storage while managing two separate drives making the content management easier.

In the present embodiment, the USB female connector 115 generally interfaces with a host device, via the USB port, to decode data-read, data-write, and data-delete commands. Additionally, the USB female connector 115 allows a form of electrical power, commonly known as milliamps, to flow to the host device or from the host device to the circuit board 105. In the present embodiment, the USB female connector 115 establishes contact with a host device in compliance with the USB standard, which has been adopted by the industry. In the present embodiment, the device 100 houses within 110 a micro male USB type-B connector 130, which is lockable in both a retracted state and an extended state.

The extension and the retraction of the micro male USB type-B connector 130 through a fabricated hole 135 in the housing 110 is controlled by a recessed lever 140. The micro male USB type-B connector 130 is used when extended. In a non-limiting example, the recessed lever 140 in FIGS. 1B, 1E and 1F is illustrated in the extended state, thereby extending the micro male USB type-B connector 130. In one non-limiting example, the recessed lever 140 in FIGS. 1C and 1D is illustrated in a retracted state, thereby retracting the micro male USB type-B connector 130. In a second non-limiting example, the micro male USB type-B connector 130 may be coupled with a device that uses a micro female USB Type-B connector. In the present embodiment, the micro male USB type-B connector 130 either decodes the data-read, data-write, and data-delete commands of the host or adopts the role of host with standard USB on-the-go (OTG) protocols. In addition, the micro male USB type-B connector 130 allows a form of electrical power, commonly known as milliamps, to bi-directionally flow between the micro male USB type-B connector 130 and the host.

In the present embodiment, the microSD reader drive slot 120 constitutes a socket for inserting microSD cards 125; the insertion activates a signal and the removal deactivates the signal. Once a signal is activated, the microcontroller can read or delete data in the microSD card 125, or write the data into the semiconductor switch, where it becomes possible to automatically shift the functions based on the microSD card and the switch. In a non-limiting example, this allows the host device to see multiple memory device drives. The switch detects the presence of a single memory source or multiple memory sources which allows for instantly accessing the inserted memory. In some embodiments, the switch may be a software switch.

In the present embodiment, a cap 145, which is constructed from two pieces of lightweight, durable plastic, is attached to the housing 110. The cap 145 may be locked in two positions: In a non-limiting example, FIGS. 1B and 1F illustrate the cap 145 in the retracted position, which allows the USB female connector 115 to be connected to any USB enabled devices; however, the USB female connector 115 is exposed to damage. In a non-limiting example, FIGS. 1C, 1D, 1E, and 1F illustrate the cap 145 in the extended position, which protects the USB female connector 115 from damage. In the present embodiment, built into the housing 110 is a storage space 150 for two spare microSD cards 165, which are stored in slotted openings 155 and 160 along one of the longitudinal sides of the housing 110. In a non-limiting example, slot one 155 is located on the edge where the side and the top of the housing 110 meet and the slot two 160 is located on the edge where the side and the bottom of the housing 110 meet. In some embodiments, slots 155 and 160 include microSD readers for enabling inserted microSD cards to appear as additional drives. Attached to the housing 110 is a key ring 170.

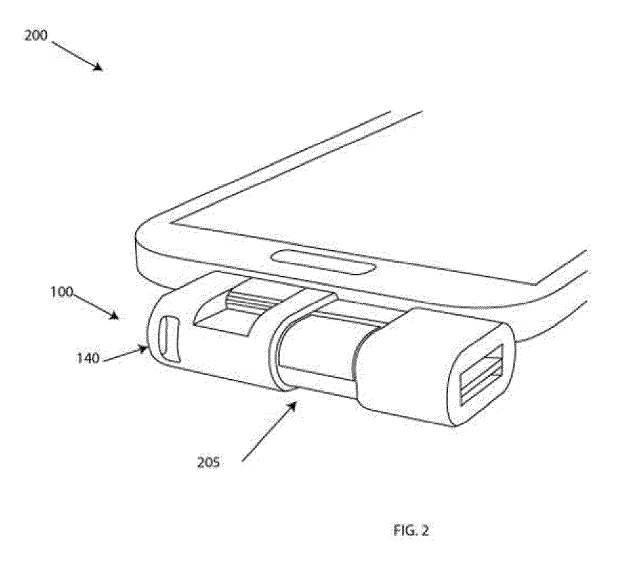

FIG. 2 illustrates an exemplary device 100 inserted into an OTG smart device, in accordance with an embodiment of the present invention. In the present embodiment, device 100 mounts horizontally 205 to a smart device via the micro male USB type-B connector 130 located on the side of device 100 by, without limitation, a flexible ribbon cable that allows retraction. In a non-limiting example, the horizontal mount 205 creates a compact, low-profile design. In another non-limiting example, the low-profile design makes the device 100 portable while attached to a smart device. In another non-limiting example, the horizontal mount 205 enables the user to keep the device 100 plugged in and active while performing everyday activities such as keeping a smart device in a pant pocket or a jacket pocket. In the present embodiment, the recessed lever 140 is extended, allowing the micro male USB type-B connector 130 to be used by the smart device.

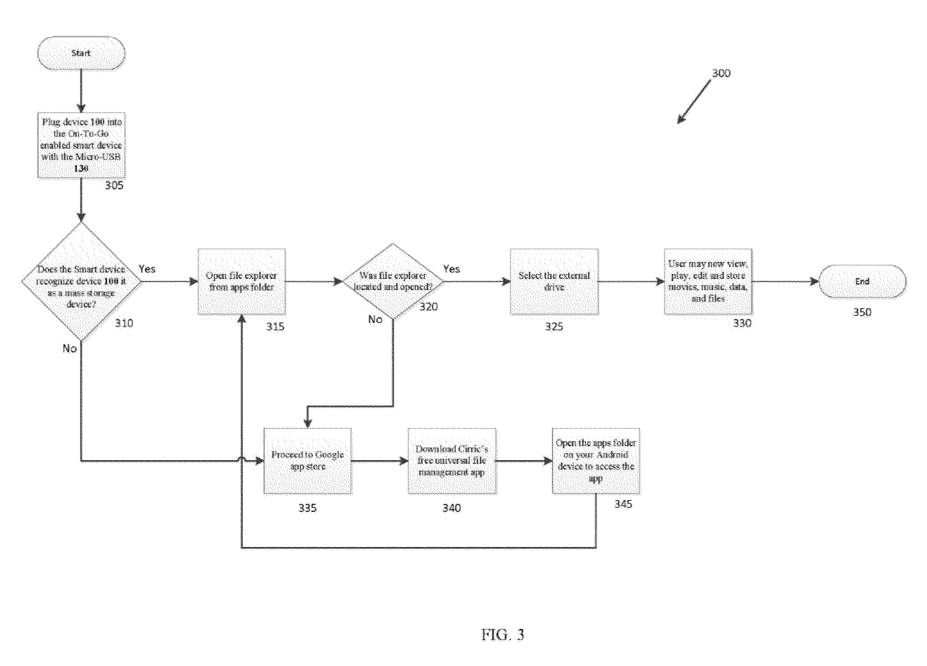

FIG. 3 illustrates an exemplary method for using the device 100, in accordance with an embodiment of the present invention. A first step of the present embodiment may begin with a step 305 where the user inserts the device 100 by way of the micro male USB type-B connector 130 into the micro-USB port on the on-to-go (OTG)-enabled smart device. The OTG-enabled smart device recognizes the device 100 as a mass-storage device in a step 310. To access the drive, the user will open the file explorer, in a step 315, verify that explorer opened, at a step 320, and select the external drive step in a 325. This will now allow the user to view, edit, and store movies, music, data, and files in a step 330. If the OTG-enabled smart device does not recognize device 100 as a mass storage device, in a step 310, or if the user was not able to access the file explorer, in a step 320, the user will proceed to Google's app store in a step 335 to download Cirric's free universal-file-management app in a step 340. Once the universal-file-management app is downloaded in a step 345, the user will open the app folder on smartphone, in a step 345, access the file explorer app in a step 315, verify that explorer opened, at a step 320, and select the external drive in a step 325. This will now allow the user view, edit, and store movies, music, data, and files in a step 330.

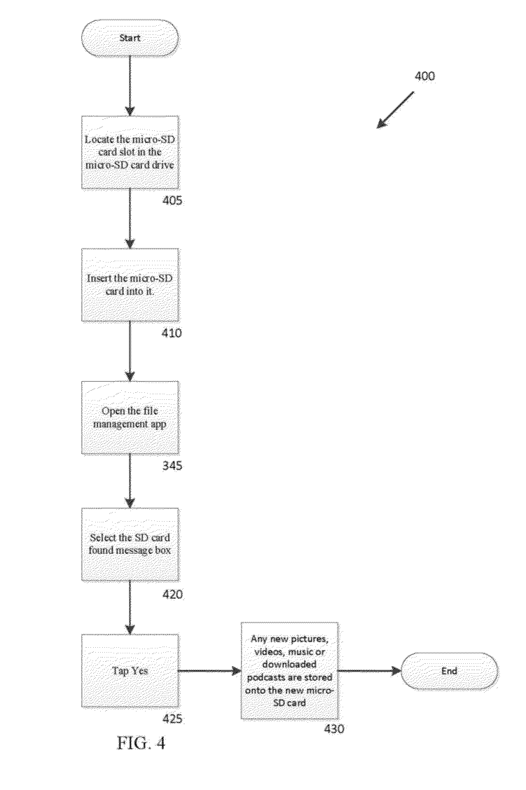

FIG. 4 illustrates an exemplary method for adding storage to the device 100, in accordance with an embodiment of the present invention. A first step of the present embodiment may begin with a step 405 where the user locates the microSD card slot 120 for the microSD reader. The user will insert the microSD card 125 into the slot 120 of the microSD card reader in a step 410. The user will open the file-management app in a step 345, select the “microSD card found” message box in a step 420, and select “Yes” in a step 425. This will allow the user to store any new pictures, videos, music, or downloaded podcasts in the new microSD card 125 in a step 430.

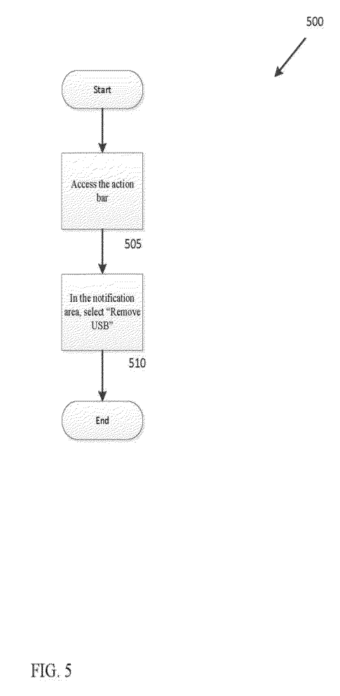

FIG. 5 illustrates an exemplary method for ejecting the device 100, in accordance with an embodiment of the present invention. A first step of the present embodiment may begin with a step 505 where the user may access the action bar and in the notification area, select “Remove USB” in a step 510.

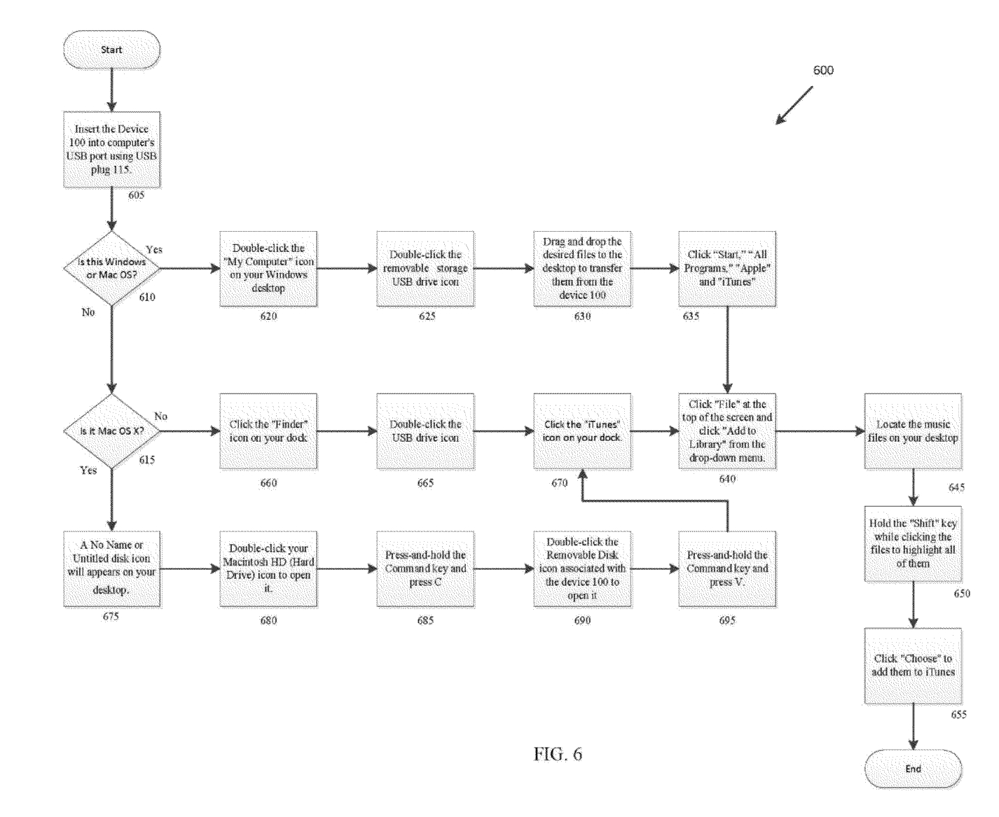

FIG. 6 illustrates an exemplary method for downloading music from the device 100 to iTunes® software on a computer, in accordance with an embodiment of the present invention. A first step of the present embodiment may begin with a step 605 where the user inserts the device 100 via the USB type-A connector 115 into a computer's USB port. The user determines whether the operating system is Windows based or Mac based in a step 610, and, if Mac based, determines whether the operating system is Mac OS X in a step 615. If the user determines the operating system to be Windows based in a step 610, the user will double click the “My Computer” icon on the desktop in a step 620. The user will then double click the “removable-storage USB drive icon in a step 625, and use the drag-and-drop method to transfer the desired files to the desktop from the device 100 in a step 630. The user will then open iTunes® by clicking Start>All Programs>Apple>iTunes in a step 635. If the user determines the operating system to be Mac, in a step 610, but not Mac OS X, in a step 615, the user will click the “Finder” icon on Mac's dock in a step 660, double-click the USB drive icon in a step 665 and click the “iTunes” icon on the Mac's dock in a step 670. If, on the other hand, the user determines that the operating system is Mac OS X in a step 615, the user will look for typically a No Name or Untitled disk icon on the desktop in a step 675. Once found, the user will double-click the Macintosh hard drive (HD) icon to open it in a step 680. The user will press and hold the “Command” key and then press “C” key in a step 685. The user may then double click the “Removable Disk” icon associated with the device 100 to open it in a step 690 and, in a step 695, press and hold the “Command” key and then press the “V” key. To access iTunes®, the user will click on the “iTunes” icon on the Mac's dock in a step 670. Once inside iTunes, the user will click File>Add to Library in a step 640. The user will switch back to the desktop view locating the desired music files, in a step 645, and hold “Shift” while clicking the files to highlight all of them in a step 650. Finally, the user will click “Choose” to add the selected files to iTunes in a step 655.

In some embodiments, the device 100 in the Apple platform must be stripped down to meet the Made for iPhone (MFI) certification, where the external storage compartments 150 are removed and the USB micoSD card reader 125 is replaced with a standard USB housing.

In some embodiments, the device 100 is compatible with both the PC windows based and Mac OS systems. Specifically, the device 100 may be used, without limitation, on PC operating systems running Windows 8, Windows 7, and Windows Vista and, without limitation, on Mac iOS version 9 or later OS X.

In some embodiments, the device 100, on both the iPhone and Android OTG enabled smart devices, may have an on board memory capacity of 16 GB, 32 GB, 64 GB, or 128 GB at a USB transfer rate of 12 MB/s while reading and 7.5 MB/s for writing.

In some embodiments, the device 100, on iPhone and Android OTG enabled smart devices, utilize the Android Smart Device free universal app that typically features an automatic detection of any USB compatible devices and directs the user to download the app which is an interface with Mac iOS version 9 or later, iOS X, Windows XP, Windows 7, Windows 8, and Linux Kernel version 2.4 or later.

In some embodiments, the device 100 supports the user to watch movies and play music play directly from the external memory with the movie play back feature streaming at, without limitation, 1080p HD in both the Android and iPhone platforms.

In some embodiments, the device 100 supports, in both iPhone and Android OTG smart devices, the user to have file management control where the user may create, copy, cut, paste, delete, rename, and/or create folders files directly on the device 100.

In some embodiments, the device 100 supports, in both iPhone and Android OTG smart devices, the user may open and/or view, without limitation, images, photos, videos, and documents with the following file extensions: .doc and .docx, .htm, .html, .key, .numbers, .pages, .pdf, .ppt, .pptx, .txt, .rtf, .vcf, .xls, .xlsx, .zip, .ics, bmp, tif, tiff, xbm, gif, ico, cur, jpg, png, AVI, Fly, MP4, MOV, MPV, M4V, MKV, MPG, RM, RMVB, TS, WMV, way, .aac, .aif, .aiff, .caf, .m4a, and .mp3.

In some embodiments, the device 100 supports, in the Android OTG smart device, the user to backup and restore contacts, to open files from other apps in device 100's app and to open files from device 100 in other apps.

In some embodiments, the USB metal plug 115 is a specially designed type of connector.

In some embodiments, the male micro USB Type B device plug 130 may be a Lightning device plug.

In some embodiments, the male micro USB Type B device plug 130 may couple to another device that utilizes a female Lightning device plug.

In some embodiments, the housing 110 may be constructed, without limitation, from ABS plastic, brushed aluminum, or high-impact polycarbonates.

In some embodiments, the device 100 may be operational in other devices such as, without limitation, Apple's iPad (4th Generation), iPad mini, iPad mini with Retina display, iPad Air, and iPod Touch (5th Generation).

In some embodiments, the storage space 150 contains two separate hinged doors to cover and protect slotted openings 155 and 160.

Those skilled in the art will readily recognize, in light of and in accordance with the teachings of the present invention, that any of the foregoing steps and/or system modules may be suitably replaced, reordered, or removed and that additional steps and/or system modules may be inserted depending upon the needs of the particular application, and that the systems of the foregoing embodiments may be implemented using any of a wide variety of suitable processes and system modules, and are not limited to any particular computer hardware, software, middleware, firmware, microcode, and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: web site hosting and cloud storage for databases.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a flash memory and memory card reader according to the present invention will be apparent to those skilled in the art. Various aspects of the invention have been described above by way of illustration, and the specific embodiments disclosed are not intended to limit the invention to the particular forms disclosed. The particular implementation of the flash memory and memory card reader may vary depending upon the particular context or application. By way of example, and not limitation, the flash memory and memory card reader described in the foregoing were principally directed to multiple USB and microSD implementations; however, similar techniques may instead be applied to other useful implementations, such as, without limitation, other flash memory or data storage devices using Wi-Fi technology, in which the implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus comprising:
a housing comprising a generally oblong shape with a first lateral side, a second lateral side, a first lateral end and a second lateral end;
a memory device being disposed within said housing;
a first connector being disposed on said first lateral end, said first connector being configured for connecting with a host computer, said first connector being connected to said memory device, said first connector comprising a slot being configured for accepting a microSD card, wherein the host computer, in communication with said first connector, has access to said memory device and a microSD card inserted in said slot; and
a second connector being disposed on said first lateral side, said second connector being configured for connecting with a portable computing device, said second connector being connected to said memory device and a microSD card inserted in said slot, wherein the portable computing device, in communication with said second connector, has access to said memory device and a microSD card inserted in said slot.

2. The apparatus as recited in claim 1, further comprising a cap being in engagement with said housing for protecting said first connector.

3. The apparatus as recited in claim 2, in which said cap slides to an extended position for protecting said first connector.

4. The apparatus as recited in claim 1, further comprising a recessed lever in engagement with said housing and said second connector for retracting said second connector into said housing.

5. The apparatus as recited in claim 1, further comprising a plurality of slots disposed on said housing, said plurality of slots being configured for storing a plurality of microSD cards within said housing.

6. The apparatus as recited in claim 5, in which said plurality of slots comprises two slots being disposed on said second lateral side.

7. The apparatus as recited in claim 6, in which each of said two slots comprises a microSD reader.

8. The apparatus as recited in claim 1, further comprising a key ring being joined to said second lateral end.

9. The apparatus as recited in claim 1, in which said first connector and said second connector are further configured for bi-directionally passing electrical power.

10. The apparatus as recited in claim 1, in which said first connector further comprises a universal serial bus connector.

11. The apparatus as recited in claim 10, in which said universal serial bus connector of said first connector comprises dimensions of an A-Type connector.

12. The apparatus as recited in claim 1, in which said second connector further comprises a universal serial bus connector.

13. The apparatus as recited in claim 12, in which said universal serial bus connector of said second connector comprises a micro Type-B connector.

14. The apparatus as recited in claim 1, in which the portable computing device comprises an on-the-go smart device.

15. An apparatus comprising:
means for housing;
means for storing data within said housing means;
first means for connecting with a host computer, wherein the host computer, in communication with said first means, has access to said means for storing data and a microSD card inserted in said first means; and
second means for connecting with a portable computing device, wherein the portable computing device, in communication with said second means, has access to said means for storing data and a microSD card inserted in said first means.

16. The apparatus as recited in claim 15, further comprising means for protecting said first means.

17. The apparatus as recited in claim 15, further comprising means for retracting said second means into said means for housing.

18. The apparatus as recited in claim 15, further comprising means for storing a plurality of microSD cards within said means for housing.

19. The apparatus as recited in claim 15, further comprising means for joining to a key ring.

20. An apparatus comprising:
a housing comprising a generally oblong shape with a first lateral side, a second lateral side, a first lateral end and a second lateral end;
a memory device being disposed within said housing;
a first connector being disposed on said first lateral end, said first connector being configured for connecting with a host computer and for bi-directionally passing electrical power, said first connector being connected to said memory device, said first connector comprising a slot being configured for accepting a microSD card, said first connector further comprising a universal serial bus connector having dimensions of an A-Type connector, wherein the host computer, in communication with said first connector, has access to said memory device and a microSD card inserted in said slot;
a second connector being disposed on said first lateral side, said second connector being configured for connecting with an on-the-go smart device and for bi-directionally passing electrical power, said second connector further comprising micro universal serial bus connector Type-B, said second connector being connected to said memory device and a microSD card inserted in said slot, wherein the on-the-go smart device, in communication with said second connector, has access to said memory device and a microSD card inserted in said slot;
a cap being in engagement with said housing for protecting said first connector, in which said cap slides to an extended position for protecting said first connector;
a recessed lever in engagement with said housing and said second connector for retracting said second connector into said housing;
at least two slots disposed on said second lateral side, said slots being configured for storing a microSD cards within said housing, in which each of said two slots comprises a microSD reader; and
a key ring being joined to said second lateral end.
